(19) United States
(12) Patent Application Publication
(10) Pub. No.: US 2026/0296415 A1
(43) Pub. Date: Oct. 1, 2026

(54) CONTROL DEVICE, CONTROL METHOD, AND NON-TRANSITORY COMPUTER-READABLE STORAGE MEDIUM

(71) Applicant: HONDA MOTOR CO., LTD., Tokyo (JP)

(72) Inventors: Hiroyuki TAKASAKI, Tokyo (JP); Fumiaki YOSHIKAWA, Tokyo (JP)

(73) Assignee: HONDA MOTOR CO., LTD., Tokyo (JP)

(21) Appl. No.: 19/095,819

(22) Filed: Mar. 31, 2025

(51) Int. Cl. B60W 30/095; B60W 30/06; B60W 50/14; B60W 60/00

(52) U.S. Cl. CPC B60W 30/095; B60W 30/06; B60W 50/14; B60W 60/001; B60W 2050/146

(57) ABSTRACT

A control device for a moving object has a recognition unit that acquires external environment information related to a surrounding situation of a moving object which autonomously moves from a parking start position to a destined parking position and to which a towed vehicle is connectable, a first acquisition unit that acquires towed vehicle information related to the towed vehicle connected to the moving object, a second acquisition unit that acquires route information acquired when the moving object travels on a first travel route from the parking start position to the destined parking position, and a movement control unit that performs travel control of the moving object. The movement control unit generates a second travel route that is a trajectory through which the towed vehicle passes when the moving object to which the towed vehicle is connected travels on the first travel route.

### TECHNICAL FIELD

The present disclosure relates to a control device, a control method, and a non-transitory computer-readable storage medium storing a control program.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been focused on.

In the related art, it is known that in an automated driving system that causes a vehicle to travel autonomously without requiring a driving operation of a user, a route taken when the vehicle travels to a destined position by driving operations of the user is stored, and the vehicle is caused to travel based on a stored route history when the vehicle travels toward the same destined position or on the same route. Further, it is known that route information from a current position to the destined position is generated based on information acquired by an in-vehicle sensor and the vehicle is caused to travel.

JP2020-117128A describes a parking assistance device configured to execute automated parking control based on image data acquired by imaging surroundings of a vehicle when a first instruction from an instruction device is received, store a position determined based on a position of the vehicle at a time point when the vehicle is set to a parked state by the automated parking control as a registered parking position, and execute the automated parking control after setting the stored registered parking position as a destined parking position when a second instruction from the instruction device is received.

JP2018-176909A describes a parking assistance device that calculates a parking route from a stop position of a host vehicle to a parking space and resets a new parking route in a case where an obstacle is present in the middle of the parking route.

The parking assistance device described in each of JP2020-117128A and JP2018-176909A performs automated parking based on travel route information of the host vehicle. Therefore, for example, in a case where the host vehicle is connected to a towed vehicle, when the automated parking is performed based on the registered route information or the calculated parking route, since a travel trajectory of the towed vehicle is different from a travel trajectory of the host vehicle, a problem such as contact with an obstacle or entanglement may occur. JP2020-117128A and JP2018-176909A do not disclose setting a travel route in consideration of the travel trajectory of the towed vehicle.

### SUMMARY OF INVENTION

An object of the present disclosure is to provide a control device, a control method, and a non-transitory computer-readable storage medium storing a control program capable of improving safety of automated parking. This hence contributes to development of a sustainable transportation system.

A first aspect of the present disclosure relates to a control device for a moving object which autonomously moves from a parking start position to a destined parking position and to which a towed vehicle is connectable, the control device comprising:
an external environment recognition unit configured to acquire external environment information related to a surrounding situation of the moving object;
a first acquisition unit configured to acquire towed vehicle information related to the towed vehicle connected to the moving object;
a second acquisition unit configured to acquire route information acquired when the moving object travels on a first travel route from the parking start position to the destined parking position; and
a movement control unit configured to perform travel control of the moving object travelling to the destined parking position based on the external environment information and the route information,
wherein the movement control unit generates, based on the towed vehicle information and the route information, a second travel route that is a trajectory through which the towed vehicle passes when the moving object to which the towed vehicle is connected travels on the first travel route.

A second aspect of the present disclosure relates to a control method in a control device for a moving object which autonomously moves from a parking start position to a destined parking position and to which a towed vehicle is connectable,
wherein a processor of the control device performs the control method comprising:
   acquiring external environment information related to a surrounding situation of the moving object;
   acquiring towed vehicle information related to the towed vehicle connected to the moving object;
   acquiring route information acquired when the moving object travels on a first travel route from the parking start position to the destined parking position;
   performing travel control of the moving object travelling to the destined parking position based on the external environment information and the route information; and
   generating, based on the towed vehicle information and the route information, a second travel route that is a trajectory through which the towed vehicle passes when the moving object to which the towed vehicle is connected travels on the first travel route.

A third aspect of the present disclosure relates to a non-transitory computer-readable storage medium storing a control program of a control device for a moving object which autonomously moves from a parking start position to a destined parking position and to which a towed vehicle is connectable, the control program causing a processor of the control device to:
acquire external environment information related to a surrounding situation of the moving object;
acquire towed vehicle information related to the towed vehicle connected to the moving object;
acquire route information acquired when the moving object travels on a first travel route from the parking start position to the destined parking position;
perform travel control of the moving object travelling to the destined parking position based on the external environment information and the route information; and
generate, based on the towed vehicle information and the route information, a second travel route that is a trajectory through which the towed vehicle passes when the moving object to which the towed vehicle is connected travels on the first travel route.

According to the aspects of the present disclosure, it is possible to provide the control device, the control method, and the non-transitory computer-readable storage medium storing the control program capable of improving safety of the automated parking.

### BRIEF DESCRIPTION OF DRAWINGS

Exemplary embodiment(s) of the present invention will be described in detail based on the following figures, wherein:

FIG. 1 is a side view of a vehicle 1 on which a control device according to the present disclosure is mounted;

FIG. 2 is a top view of the vehicle 1 shown in FIG. 1;

FIG. 3 is a block diagram showing an example of an internal configuration of the vehicle 1 shown in FIG. 1;

FIG. 4 is a diagram showing an example in which the vehicle 1 is to be parked to a destined parking position 220 by manual driving of a user;

FIG. 5 is a diagram showing a state where the vehicle 1 towing a towed vehicle 3 travels on a manual-driving travel route 230 shown in FIG. 4;

FIG. 6 is a diagram showing an example of a first travel route of the vehicle 1 and a second travel route of the towed vehicle 3 displayed on a navigation device 20;

FIG. 7 is a diagram showing an example of a user operation of changing a first travel route 241 of the vehicle 1;

FIG. 8 is a flowchart showing an example of processing of a control device 30 at the start of automated parking;

FIG. 9 is a flowchart showing a modification of the processing of the control device 30 at the start of the automated parking;

FIG. 10 is a flowchart showing an example of processing of the control device 30 during vehicle traveling in the automated parking; and

FIG. 11 is a flowchart showing a modification of the processing of the control device 30 during the vehicle traveling in the automated parking.

### DESCRIPTION OF EMBODIMENTS

Hereinafter, an embodiment of a control device, a control method, and a control program of the present disclosure will be described with reference to the drawings. The drawings are viewed in directions of reference numerals. The following embodiment does not limit the present disclosure, and not all of elements described in the following embodiment are necessary to the present invention. Hereinafter, the same or similar elements are denoted by the same or similar reference signs, and the description thereof may be omitted or simplified.

### Vehicle

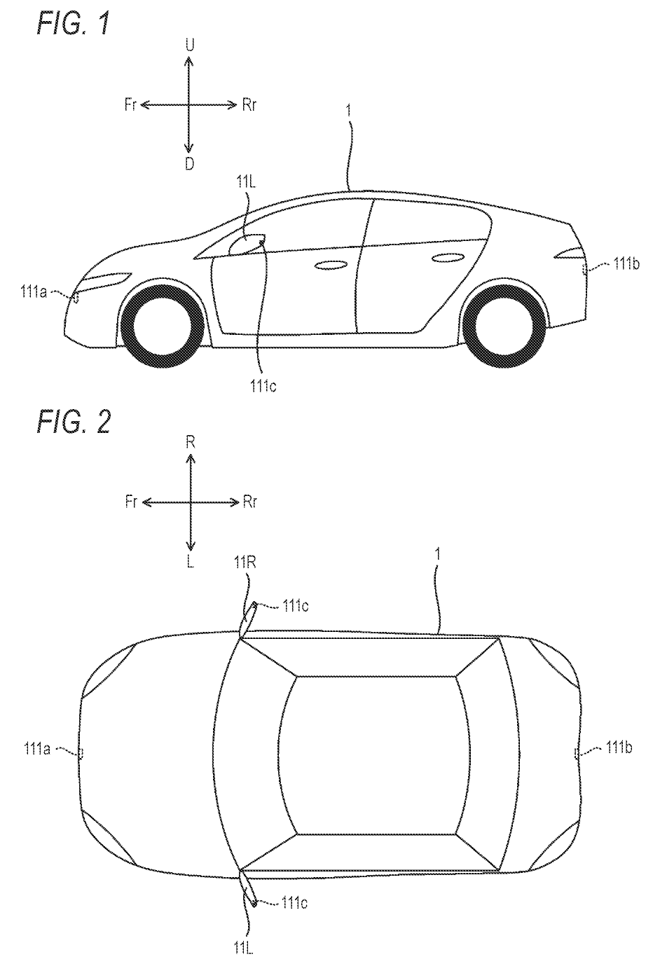

FIG. 1 is a side view of a vehicle 1 on which a control device according to the present disclosure is mounted. FIG. 2 is a top view of the vehicle 1 shown in FIG. 1. The vehicle 1 is an example of a moving object of the present disclosure. The vehicle 1 according to the present embodiment is an automobile including a drive source (not shown), and wheels (not shown) including drive wheels driven by power of the drive source and steered wheels that are steerable. The vehicle 1 is an automobile to which a towed vehicle (for example, a trailer) can be connected. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of the electric motor and the internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 further includes side mirrors 11L and 11R. The side mirrors 11L and 11R are mirrors (back mirrors) provided on outer sides of front seat doors of the vehicle 1 for a driver to check a rear side and rear lateral sides. The side mirrors 11L and 11R are fixed to a main body of the vehicle 1 by rotation shafts extending in a vertical direction, and can be opened and closed by rotating about the rotation shafts.

The vehicle 1 further includes a front camera 111a, a rear camera 111b, and side cameras 111c. The front camera 111a is a digital camera that is provided on a front side of the vehicle 1 and images the front side of the vehicle 1. The rear camera 111b is a digital camera that is provided on a rear side of the vehicle 1 and images the rear side of the vehicle 1. The side cameras 111c are digital cameras that are respectively provided on the left and right side mirrors 11L and 11R of the vehicle 1 and images a left or right side of the vehicle 1.

### Internal Configuration of Vehicle

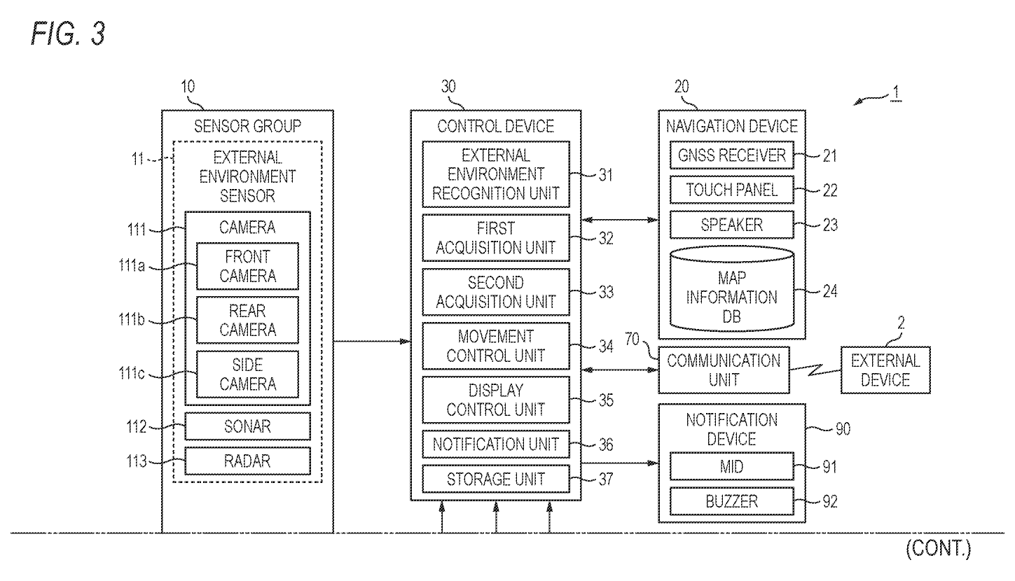

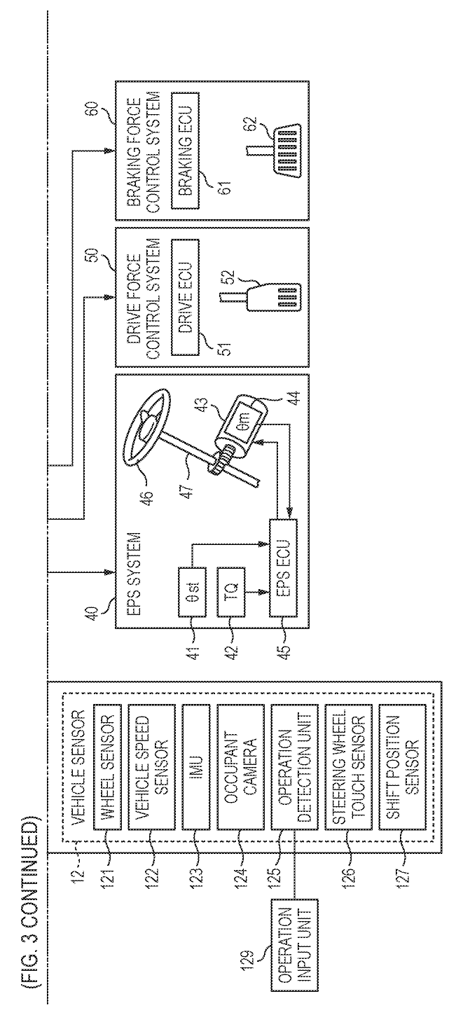

FIG. 3 is a block diagram showing an example of an internal configuration of the vehicle 1 shown in FIG. 1. The vehicle 1 includes a sensor group 10, a navigation device 20, a control device 30, an electric power steering (EPS) system 40, a drive force control system 50, a braking force control system 60, a communication unit 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as "vehicle information"). The information acquired by each sensor in the sensor group 10 is output to the control device 30, and is used for control of the vehicle 1 (hereinafter, also referred to as "vehicle control") performed by the control device 30.

The external environment sensor 11 includes, for example, the cameras 111, the sonar 112, and the radar 113. The cameras 111 image the periphery of the vehicle 1 including the front side of the vehicle 1 and output image data of the obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, the front camera 111a, the rear camera 111b, and the side cameras 111c. The front camera 111a is provided, for example, on an upper portion of a front window or a front grille (not shown) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on the left and right side mirrors 11L and 11R, and image scenes on lateral sides (that is, the left and right sides) of the vehicle 1. The peripheral images of the vehicle 1 captured by the front camera 111a, the rear camera 111b, the side camera 111c on the left side, and the side camera 111c on the right side are also referred to as a front image, a rear image, a left side image, and a right side image, respectively. An image constituted by the left side image and the right side image may be referred to as a lateral side image. The peripheral image of the vehicle 1 generated by synthesizing the imaging data of the front camera 111a, the rear camera 111b, and the left and right side cameras 111c may be referred to as an overhead image.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, an azimuth of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering wheel touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images a vehicle interior of the vehicle 1 and outputs image data of an obtained vehicle interior image to the control device 30. For example, the occupant camera 124 can be a so-called "driver monitor camera" provided to be able to image a head of an occupant seated in a driver seat of the vehicle 1 (for example, a user driving the vehicle 1, hereinafter simply referred to as "user") from the front. Similar to the camera 111, a digital camera using an imaging element such as the CCD or the CMOS can be adopted as the occupant camera 124.

The operation detection unit 125 detects an operation performed by using an operation input unit 129 that is operable by the user. The operation input unit 129 may include, for example, a switch or a button that receives a command related to parking assistance to be described later.

The steering wheel touch sensor 126 detects whether a steering wheel 46 of the vehicle 1 is gripped appropriately. For example, the steering wheel touch sensor 126 is implemented by a capacitance sensor or the like. In this case, the capacitance sensor is provided at a portion touched by the user when the steering wheel 46 is gripped appropriately.

The shift position sensor 127 detects, for example, whether a shift position of a shift lever (not shown) provided in the vehicle 1 is any one of "P (parking)", "R (reverse)", "N (neutral)", and "D (drive)". When the vehicle 1 may take another shift position (for example, "B (brake)") other than the "P", the "R", the "N", and the "D", the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing a road based on a combination of nodes and links connecting the nodes (also referred to as "paths"). Each of the nodes in the road network information represents, for example, a feature of the road such as an intersection, a corner, or a dead end. In the road network information, for each of the nodes, for example, information indicating a location corresponding to the node (for example, coordinates that enable specifying of one location on a map such as a latitude and a longitude) is set. Further, in the road network information, for each of the links, information indicating nodes at both ends of the link, a road corresponding to the link, a link length, the number of lanes, a travel direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 is implemented by combining a display device such as a liquid crystal display or an organic light emitting diode (OLED) with a pointing device (for example, a touchpad). The speaker 23 is configured to output sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

The navigation device 20 may cause the touch panel 22 to perform a predetermined display according to an instruction from the control device 30. Further, the navigation device 20 may output predetermined information (for example, information indicating an operation received via the touch panel 22) to the control device 30.

For example, the navigation device 20 may cause, according to the instruction from the control device 30, the touch panel 22 to display an operation button for receiving a command request related to the parking assistance. Further, the navigation device 20 may output, to the control device 30, operation information of the command request related to the parking assistance received via the touch panel 22. The "parking assistance" means assistance for parking the vehicle 1 to a predetermined parking position.

Specifically, the navigation device 20 causes the touch panel 22 to display a parking assistance button for requesting the parking assistance of the vehicle 1. The parking assistance button includes an automated parking button for requesting parking that is based on automatic steering of the control device 30, and a parking support button for requesting support during parking of the vehicle 1 that is based on an operation of the driver. When the parking assistance button is operated via the touch panel 22, the navigation device 20 outputs the operation information to the control device 30.

The navigation device 20 causes the touch panel 22 to display the overhead image of the vehicle 1 and the periphery of the vehicle 1. Further, the navigation device 20 causes the touch panel 22 to display a three-dimensional (3D) image in which the peripheral image of the vehicle 1 and an image of the vehicle 1 are superimposed. Although the touch panel 22 of the navigation device 20 is used as an input device or a display device in this example, for example, a head-up display (HUD), a smartphone, a tablet terminal, or the like may be used.

The "parking" is synonymous with, for example, "parking". For example, the "parking" is a stop as the occupant gets on and off the vehicle, and excludes a temporary stop due to a traffic signal or the like. Further, the "parking position" means a position where the vehicle 1 is to be stopped, that is, a position to be parked to.

The control device 30 is an example of a control device according to the present disclosure and is a computer that integrally controls the entire vehicle 1. The control device 30 includes, for example, a processor (not shown) that performs various calculations, a storage unit 37 including a non-transitory storage medium that stores various types of information (for example, programs and various types of data), and an input and output unit (not shown) as an interface that controls input and output of data between the inside and the outside of the control device 30.

The control device 30 includes, for example, an external environment recognition unit 31, a first acquisition unit 32, a second acquisition unit 33, a movement control unit 34, a display control unit 35, and a notification unit 36 as functional units realized by the processor executing the programs stored in the storage unit 37. These functional units will be described later, and thus the description thereof will be omitted here. For example, the control device 30 is implemented by one electronic control unit (ECU) or by a plurality of ECUs working in cooperation with each other.

The EPS system 40 includes a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 assists the user in operating the steering wheel 46 by applying, according to an instruction from the EPS ECU 45, a drive force or a reaction force to a steering column 47 coupled to the steering wheel 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering wheel 46 to the control device 30. In this case, the steering speed ω is obtained by, for example, differentiating the steering angle θst with respect to time.

The drive force control system 50 includes a drive ECU 51, and is configured to control a drive force of the vehicle 1. The drive ECU 51 is a computer that includes, for example, a processor that performs various calculations, a storage unit including a non-transitory storage medium that stores various types of information, and an input and output unit that controls input and output of data between the inside and the outside of the drive ECU 51 (none is shown), and controls the drive force control system 50. The drive ECU 51 is implemented by one or more ECUs. For example, the drive ECU 51 controls power output from the drive source of the vehicle 1 based on an operation on an accelerator pedal 52 provided in the vehicle 1. The drive ECU 51 can also control the drive force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1 based on an operation on a brake pedal 62 provided in the vehicle 1. Here, the brake device includes, for example, a brake caliper, a cylinder that transmits a hydraulic pressure to the brake caliper, and an electric motor that generates the hydraulic pressure in the cylinder. The braking ECU 61 controls the electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under control of the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

Next, each functional unit of the control device 30 will be described in detail. For example, the external environment recognition unit 31 acquires external environment information regarding a surrounding situation of the vehicle 1. The external environment recognition unit 31 acquires the external environment information from the external environment sensor 11.

The first acquisition unit 32 acquires towed vehicle information on a towed vehicle connected to the vehicle 1. The "towed vehicle information" includes, for example, a size, a maximum angle, a wheelbase, a distance to a hitch member, a maximum hitch angle, and a maximum allowed gradient of the towed vehicle (for example, a trailer).

The second acquisition unit 33 acquires route information acquired when the vehicle 1 travels on a first travel route from a parking start position to a destined parking position. The "travel" is traveling in a state where the towed vehicle is not towed. The "route information" includes information such as a travel route, an obstacle, a feature, and a travel speed of the vehicle 1 (towing vehicle).

The movement control unit 34 performs travel control of the vehicle 1 travelling to the destined parking position based on the external environment information acquired by the external environment recognition unit 31 and the route information acquired by the second acquisition unit 33. The movement control unit 34 performs travel control for autonomously moving the vehicle 1 from the parking start position to the destined parking position. The travel control is control on automated traveling such as automated parking or automated exit.

Further, based on the towed vehicle information related to the towed vehicle connected to the vehicle 1 and the route information when the vehicle 1 travels on the first travel route, the movement control unit 34 generates a second travel route, which is a trajectory through which the towed vehicle passes when the vehicle 1 to which the towed vehicle is connected travels on the first travel route. The "trajectory... passes" means a region (trajectory) to be passed through. For example, when the region overlaps an obstacle, the towed vehicle collides with the obstacle.

Further, the movement control unit 34 determines, based on the route information when the vehicle 1 travels on the first travel route, whether the towed vehicle can travel along the second travel route. The "whether ... can travel" means a collision determination as to whether traveling is possible without contact with the obstacle or the like.

When receiving an operation of changing one of the first travel route and the second travel route from the user, the movement control unit 34 changes the other one of the first travel route and the second travel route based on the received change operation. When receiving an operation of changing the first travel route, the movement control unit 34 generates the second travel route of the towed vehicle when the vehicle 1 travels on the first travel route after the change. When receiving an operation of changing the second travel route, the movement control unit 34 generates the first travel route of the vehicle 1 for causing the towed vehicle to travel on the second travel route after the change.

Further, the movement control unit 34 determines, based on the route information when the vehicle 1 travels on the first travel route, whether the towed vehicle can travel along the second travel route, and changes the first travel route such that the vehicle 1 and the towed vehicle can travel from the parking start position to the destined parking position, in a case where it is determined that the towed vehicle cannot travel along the second travel route. The movement control unit 34 performs control to change the travel route without receiving an operation from the user.

Further, based on speed information or the like (route information) when the vehicle 1 travels without being connected with the towed vehicle, the movement control unit 34 sets a travel speed of the vehicle 1 in a predetermined section among sections to the destined parking position to be lower in the case where the vehicle 1 travels while towing the towed vehicle than the case where the vehicle 1 travels without towing the towed vehicle. The "predetermined section" may be a section selected by the user or a section set by the control device 30 based on a road surface condition such as a puddle, a step, or a gradient. A section including a step may be set based on, for example, a detection result of vibration or acceleration when the vehicle climbs over the step.

When there is a step in a predetermined section of the route to the destined parking position and the vehicle 1 travels on the travel route while towing the towed vehicle, the movement control unit 34 sets the travel speed of the vehicle 1 to be lower when the towed vehicle climbs over the step than a moment when the vehicle 1 climbs over the step, based on towed vehicle information such as a distance between the rear wheels of the vehicle 1 and wheels of the towed vehicle and route information such as position information of the step present on the travel route. The "predetermined section" means, for example, a section from immediately before the vehicle 1 climbs over the step to immediately after the towed vehicle climbs over the step. The movement control unit 34 reduces the speed when the vehicle 1 climbs over the step, and further reduces the speed immediately after the vehicle 1 climbs over the step, that is, immediately before the towed vehicle climbs over the step.

Further, the movement control unit 34 determines, based on the route information when the vehicle 1 travels on the first travel route, whether the towed vehicle can travel along the second travel route, and performs travel control to cause the vehicle 1 to travel to the destined parking position along the first travel route, when it is determined that the towed vehicle can travel along the second travel route.

Further, the movement control unit 34 determines whether the towed vehicle can travel along the second travel route by predicting, based on the route information when the vehicle 1 travels on the first travel route, whether the towed vehicle and a safe region around the towed vehicle collide with an obstacle when the vehicle 1 to which the towed vehicle is connected travels on the first travel route. The "safe region around the towed vehicle" means considering not only the size of the towed vehicle but also a range (some margin) larger than the towed vehicle when determining whether the towed vehicle can travel.

The display control unit 35 causes a display unit to display the first travel route that is a trajectory through which the vehicle 1 passes when the vehicle 1 is not connected with the towed vehicle travels from the parking start position to the destined parking position, and the second travel route that is a trajectory through which the towed vehicle passes when the vehicle 1 connected with the towed vehicle travels from the parking start position to the destined parking position. The "display unit" is, for example, the touch panel 22. For example, the display control unit 35 displays the first travel route and the second travel route on the external environment information acquired by the external environment recognition unit 31 in a superimposed manner. The display control unit 35 causes the display unit to display the first travel route and the second travel route as the overhead image or the 3D image.

When it is determined that the towed vehicle cannot travel along the second travel route, the notification unit 36 issues a notification for prompting the user to change the travel route for the vehicle 1 to travel from the parking start position to the destined parking position. The "change the travel route" means a change from the first travel route. As the "notification for prompting the user to change the travel route", for example, a message such as "please change the travel route" or "please perform manual driving" may be displayed on the touch panel 22 or may be output by voice.

When it is determined that the towed vehicle cannot travel along the second travel route, the notification unit 36 issues a notification for prompting the user to perform a predetermined operation without performing the travel control for causing the vehicle 1 to travel to the destined parking position along the first travel route. The "predetermined operation" may be an operation of changing the travel route or may be a change to manual parking of the user.

Even if an operation of changing the first travel route is received from the user and the second travel route of the towed vehicle when the vehicle 1 travels on the first travel route after the change is generated, when it is determined that the towed vehicle cannot travel along the regenerated second travel route, the notification unit 36 issues a notification again. For example, even if an operation of changing the second travel route is received from the user and the first travel route of the vehicle 1 for causing the towed vehicle to travel on the second travel route after the change is generated, when it is determined that the towed vehicle cannot travel along the second travel route after the change or when it is determined that the vehicle 1 cannot travel along the regenerated first travel route, the notification unit 36 similarly issues a notification again.

### Parking of Vehicle to Destined Position

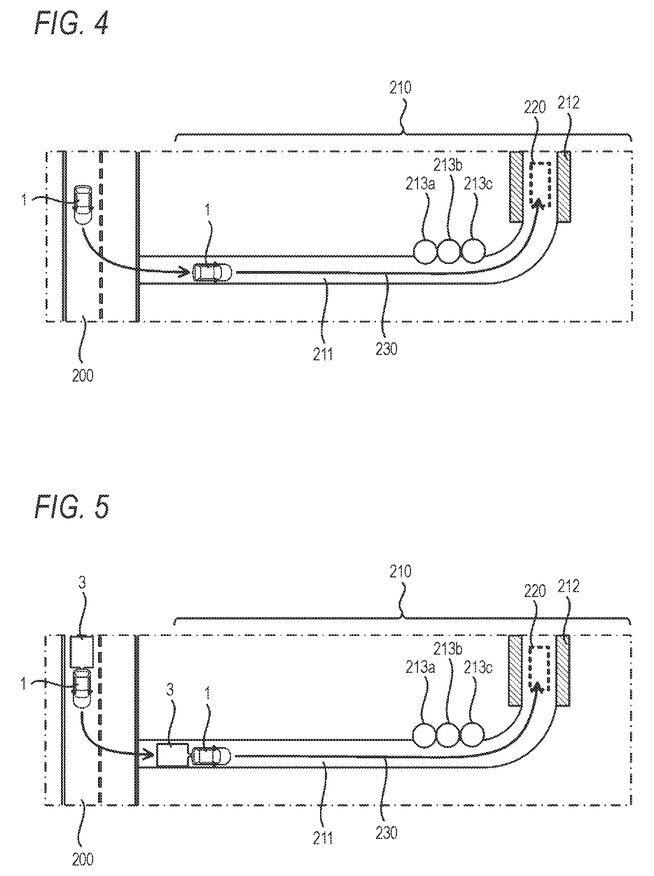

Processing for automatically parking the vehicle 1 at the destined parking position will be described with reference to FIGS. 4-7. In FIGS. 4-7, it is assumed that a destined parking position 220 at which the vehicle 1 is to be parked is, for example, a garage 212 installed in a private land 210. The private land 210 is provided with a driveway 211 that extends from the garage 212 to a general road 200. Further, it is assumed that, for example, obstacles 213a, 213b, and 213c are present beside the driveway 211.

FIG. 4 is a diagram showing an example in which the vehicle 1 is to be parked to the destined parking position 220 by manual driving of the user. In order to enable automated parking of the vehicle 1 to the destined parking position 220, first, the vehicle 1 travels to the garage 212 by manual driving of the user. Route information related to manual-driving travel route of the vehicle 1 that travels by manual driving is stored as memory travel route information. In the example shown in FIG. 4, the vehicle 1 manually driven by the user turns left on the general road 200 as indicated by a solid arrow, enters the private land 210, travels through the driveway 211 in the private land 210, and reaches the destined parking position 220 in the garage 212.

The control device 30 stores route information related to manual-driving travel route 230 indicated by a solid arrow from the general road 200 to the destined parking position 220 in the storage unit 37 as the memory travel route information. The memory travel route information includes information on the obstacles 213a, 213b, and 213c present beside the driveway 211. Thus, when the vehicle 1 travels alone (in a state where the towed vehicle is not towed) from a next time onward, automated parking to the destined parking position 220 by automated traveling is enabled using the stored memory travel route information.

FIG. 5 is a diagram showing a state where the vehicle 1 towing a towed vehicle 3 travels on the manual-driving travel route 230 shown in FIG. 4. If the memory travel route information related to the manual-driving travel route 230 is stored in the storage unit 37, the vehicle 1 starts traveling on the manual-driving travel route 230 while towing the towed vehicle 3 based on the memory travel route information. The vehicle 1 towing the towed vehicle 3 turns left on the general road 200 as indicated by a solid arrow, enters the private land 210, and travels until the driveway 211 in the private land 210 reaches the destined parking position 220 in the garage 212.

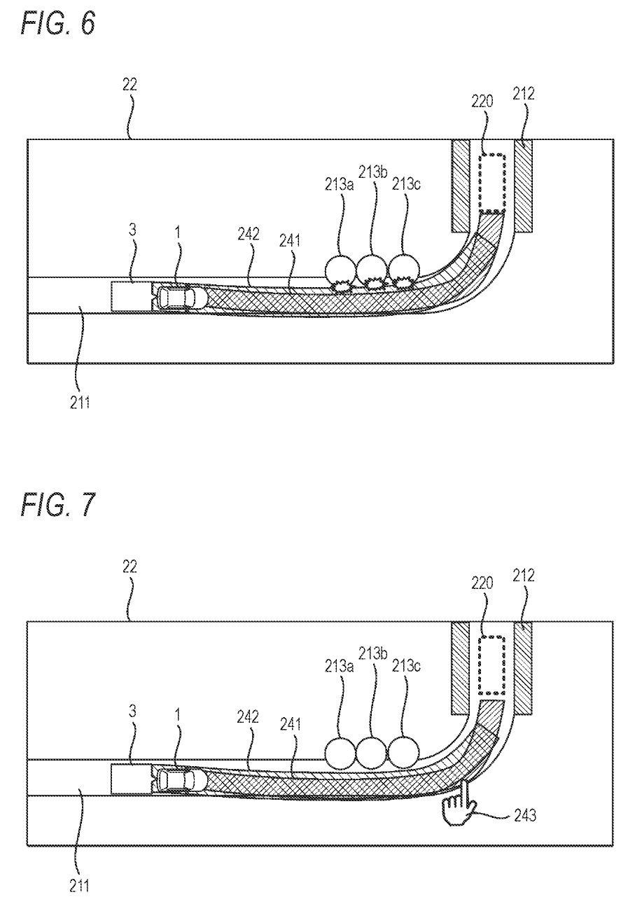

FIG. 6 is a diagram showing an example of the first travel route of the vehicle 1 and the second travel route of the towed vehicle 3 displayed on the navigation device 20. As shown in FIG. 6, a first travel route 241 and a second travel route 242 are displayed on the touch panel 22 of the navigation device 20 as, for example, the overhead image. The first travel route 241 and the second travel route 242 are displayed, for example, when the automated parking button is pressed in a case where the user parks the vehicle 1 to the destined parking position 220 by automated parking. In the example shown in FIG. 6, since the vehicle 1 is towing the towed vehicle 3, both the first travel route of the vehicle 1 and the second travel route of the towed vehicle 3 are displayed, but for example, when the vehicle 1 is not towing the towed vehicle 3, only the first travel route 241 of the vehicle 1 is displayed.

The first travel route 241 is a travel route of the vehicle 1 generated based on the memory travel route information related to the manual-driving travel route 230 described in FIG. 4. The first travel route 241 is displayed as a passing region (hatched portion) having a width, for example, as a trajectory through which the vehicle 1 passes.

The second travel route 242 is a travel route generated based on the towed vehicle information on the towed vehicle 3 and the route information when the vehicle 1 travels on the first travel route 241, and is a travel route through which the towed vehicle 3 passes when the vehicle 1 towing the towed vehicle 3 travels on the first travel route 241. The second travel route 242 is displayed as a passing region (hatched portion) having a width, for example, as a trajectory through which the towed vehicle 3 towed by the vehicle 1 passes.

As shown in FIG. 6, a width of the towed vehicle 3 is larger than a width of the vehicle 1. Therefore, the second travel route 242 of the towed vehicle 3 is a passing region having a width larger than that of the first travel route 241 of the vehicle 1. Therefore, when the vehicle 1 towing the towed vehicle 3 travels on the first travel route 241, only the second travel route 242 in the first travel route 241 and the second travel route 242 may be displayed to overlap the obstacles 213a, 213b, and 213c present beside the driveway 211. In this case, the towed vehicle 3 towed by the vehicle 1 comes into contact with the obstacles 213a, 213b, and 213c.

FIG. 7 is a diagram showing an example of a user operation of changing the first travel route 241 of the vehicle 1. The first travel route 241 of the vehicle 1 is configured to be changed by the user operation. Therefore, for example, when the vehicle 1 towing the towed vehicle 3 travels on the first travel route 241 by automated driving and the towed vehicle 3 comes into contact with the obstacles 213a, 213b, and 213c, the first travel route 241 of the vehicle 1 can be changed by the user operation in order to avoid the contact. As shown in FIG. 7, the first travel route 241 can be changed by an operation of moving a cursor 243. The operation of moving the cursor 243 is, for example, a touch operation (swipe operation) on the touch panel 22, or a press-down operation of a button or the like on the operation input unit 129.

When the first travel route 241 of the vehicle 1 is changed, a new second travel route 242 through which the towed vehicle 3 towed by the vehicle 1 passes when the vehicle 1 travels on the first travel route 241 after the change is regenerated, and the regenerated second travel route 242 is displayed on the touch panel 22 together with the first travel route 241 after the change. For example, as shown in FIG. 7, the user changes the first travel route 241 by a drag operation until the regenerated second travel route 242 does not overlap the obstacles 213a, 213b, and 213c.

The travel route may be changed by the user operation such that, for example, the second travel route 242 of the towed vehicle 3 can be changed. When the second travel route 242 of the towed vehicle 3 is changed, a new first travel route 241 of the vehicle 1 for causing the towed vehicle 3 to travel on the second travel route 242 after the change is generated.

### Processing of Control Device

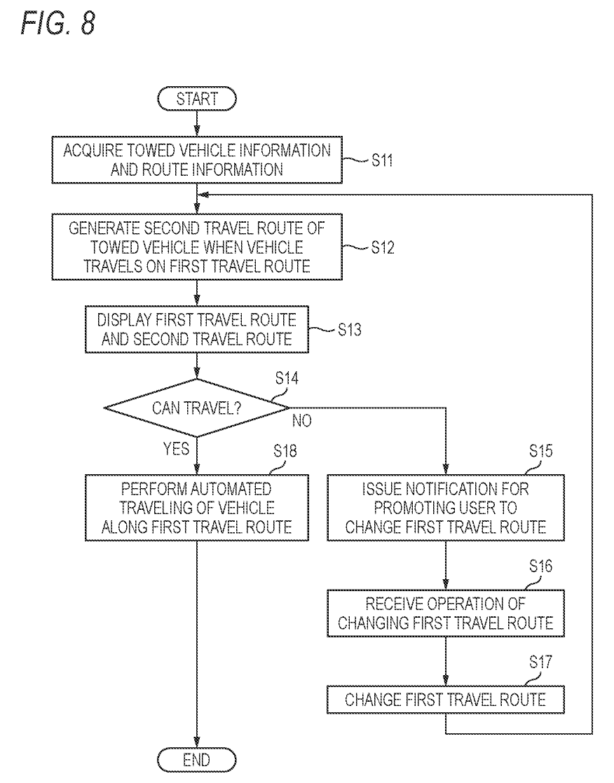

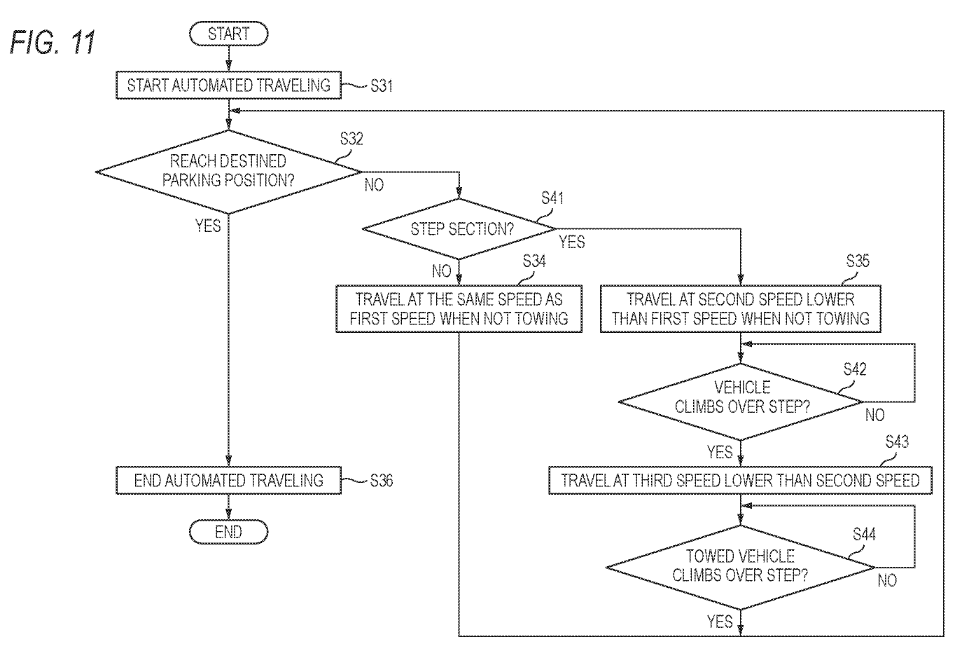

Next, processing of the control device 30 during the automated parking of the vehicle 1 will be described with reference to FIGS. 8 and 11.

### 4-1. Processing at Start of Automated Parking

FIG. 8 is a flowchart showing an example of processing of the control device 30 at the start of the automated parking. The processing in this example is started when the automated parking button is pressed to park the vehicle to which the towed vehicle is connected to the destined parking position by automatic traveling. For example, the processing is started when the vehicle 1 to which the towed vehicle 3 is connected is automatically parked to the destined parking position 220 in the garage 212 in the private land 210 shown in FIG. 4. It is assumed that the memory travel route information related to the manual-driving travel route 230 has been stored in the storage unit 37.

First, the control device 30 acquires the towed vehicle information on the towed vehicle 3 towed by the vehicle 1 and the route information when the vehicle 1 travels on the first travel route (step S11). As described above, the first travel route is the passing region (see FIG. 6) of the vehicle 1 generated based on the memory travel route information.

Next, the control device 30 generates the second travel route 242 (see FIG. 6) through which the towed vehicle 3 passes when the vehicle 1 towing the towed vehicle 3 travels on the first travel route 241 (see FIG. 6) (step S12).

The control device 30 displays the first travel route 241 of the vehicle 1 and the second travel route 242 of the towed vehicle 3 on the touch panel 22 of the navigation device 20 (step S13).

The control device 30 determines whether the towed vehicle 3 towed by the vehicle 1 can travel to the destined parking position 220 through the driveway 211 (step S14). The "can travel" means that the towed vehicle 3 can travel without coming into contact with, for example, the obstacles 213a, 213b, and 213c (see FIG. 6) present beside the driveway 211.

When it is determined in step S14 that the towed vehicle 3 cannot travel (step S14: No), the control device 30 issues a notification for promoting the user to change the first travel route 241 of the vehicle 1 (step S15).

When the user performs an operation of changing the first travel route 241 in response to the notification in step S15, the control device 30 receives the operation of changing the first travel route 241 (step S16). The user changes the first travel route 241 of the vehicle 1 by a drag operation such that the towed vehicle 3 towed by the vehicle 1 can travel to the destined parking position 220 through the driveway 211, for example, such that the towed vehicle 3 can travel without coming into contact with the obstacles 213a, 213b, and 213c present beside the driveway 211.

The control device 30 changes the first travel route 241 of the vehicle 1 based on the change operation received from the user in step S16 (step S17), and then returns to step S12 to perform each process. When returning to step S12, the control device 30 generates the second travel route 242 of the towed vehicle 3 when the vehicle 1 travels on the first travel route 241 after the change.

On the other hand, when it is determined in step S14 that the towed vehicle 3 can travel (step S14: Yes), the control device 30 executes automatic traveling of the vehicle 1 towing the towed vehicle 3 along the first travel route 241 (step S18).

In step S16, the control device 30 may receive an operation of changing the second travel route 242 of the towed vehicle 3 without being limited to the operation of changing the first travel route 241 of the vehicle 1. When the operation of changing the second travel route 242 is received, the control device 30 generates the first travel route 241 of the vehicle 1 for causing the towed vehicle 3 to travel on the second travel route 242 after the change.

When it is determined in step S14 that the towed vehicle 3 cannot travel, the control device 30 may issue a notification for promoting the user to manually drive the vehicle 1 and end the present process.

### 4-2. Modification of Processing at Start of Automated Parking

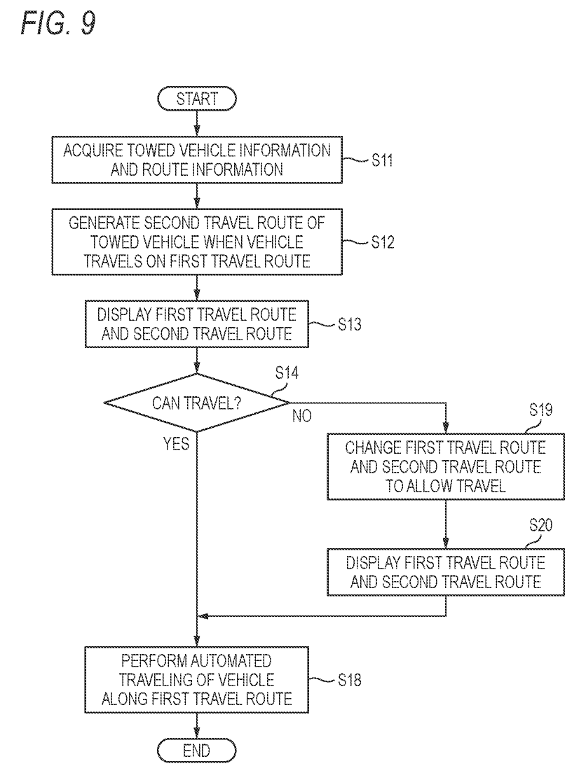

FIG. 9 is a flowchart showing a modification of the processing of the control device 30 at the start of automated parking. As shown in FIG. 9, processes from step S11 to step S14 are the same as that from step S11 to step S14 in FIG. 8.

When it is determined in step S14 that the towed vehicle 3 cannot travel (step S14: No), the control device 30 changes the first travel route 241 of the vehicle 1 and the second travel route 242 of the towed vehicle 3 such that the vehicle 1 and the towed vehicle 3 can travel to the destined parking position 220 through the driveway 211 (step S19). The control device 30 performs control to change the travel route without receiving the change operation from the user.

After the first travel route 241 after the change and the second travel route 242 after the change which are changed in step S19 are displayed on the touch panel 22 (step S20), the control device 30 proceeds to step S18 and executes automatic traveling of the vehicle 1 along the first travel route 241 after the change (step S18).

In step S19, when the first travel route 241 and the second travel route 242 cannot be changed to enable travel, the control device 30 may issue a notification for promoting the user to cause the vehicle 1 to travel by manual driving and end the present process.

### 4-3. Processing During Vehicle Traveling in Automated Parking

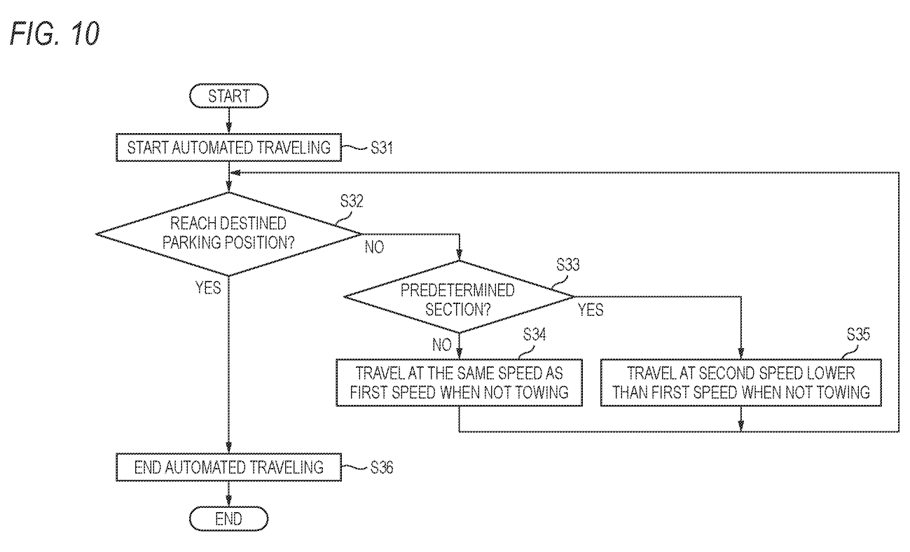

FIG. 10 is a flowchart showing an example of processing of the control device 30 during vehicle traveling in the automated parking. The processing in this example is started, for example, when the vehicle to which the towed vehicle is connected is to be parked to the destined parking position by automatic traveling. For example, the processing in this example is started when the processing at the start of the automated parking described with reference to FIG. 8 is performed and proceeds to the processing of automatic traveling along the first travel route (step S18).

The control device 30 starts the automatic traveling of the vehicle 1 towing the towed vehicle 3 (step S31).

Next, the control device 30 determines whether the vehicle 1 towing the towed vehicle 3 has reached the destined parking position 220 (step S32).

When it is determined in step S32 that the vehicle 1 towing the towed vehicle 3 has not reached the destined parking position 220 (step S32: No), the control device 30 determines whether a section in which the vehicle 1 towing the towed vehicle 3 is currently traveling is a predetermined section among sections to the destined parking position 220 (step S33). The predetermined section may be a section selected by the user as described above, or may be a section set by the control device 30 based on the road surface condition such as the puddle, the step, or the gradient.

When it is determined in step S33 that the traveling section is not the predetermined section (step S33: No), the control device 30 causes the vehicle 1 towing the towed vehicle 3 to travel at a speed the same as a first speed that is a travel speed when the vehicle 1 is not towing the towed vehicle 3 (step S34), and returns to step S32.

When it is determined in step S33 that the traveling section is the predetermined section (step S33: Yes), the control device 30 causes the vehicle 1 towing the towed vehicle 3 to travel at a second speed lower than the first speed that is the travel speed when the vehicle 1 is not towing the towed vehicle 3 (step S35), and returns to step S32.

On the other hand, when it is determined in step S32 that the vehicle 1 towing the towed vehicle 3 has reached the destined parking position 220 (step S32: Yes), the control device 30 ends the automatic traveling of the vehicle 1 towing the towed vehicle 3 (step S36).

### 4-4. Modification of Processing During Vehicle Traveling in Automated Parking

FIG. 11 is a flowchart showing a modification of the processing of the control device 30 during the vehicle traveling in the automated parking. As shown in FIG. 11, processes from step S31 to step S32 and a process of step S36 are the same as that from step S31 to step S32 and the process of step S36 in FIG. 10. In the present modification, it is assumed that the predetermined section among those to the destined parking position 220 is a step section in which a step is present.

When it is determined in step S32 that the vehicle 1 towing the towed vehicle 3 has not reached the destined parking position 220 (step S32: No), the control device 30 determines whether the section in which the vehicle 1 towing the towed vehicle 3 is currently traveling is the step section (step S41).

When it is determined in step S41 that the traveling section is not the step section (step S41: No), the control device 30 causes the vehicle 1 towing the towed vehicle 3 to travel at a speed the same as the first speed that is the travel speed when the vehicle 1 is not towing the towed vehicle 3 (step S34), and returns to step S32.

When it is determined in step S41 that the traveling section is the step section (step S41: Yes), the control device 30 causes the vehicle 1 towing the towed vehicle 3 to travel at the second speed lower than the first speed that is the travel speed when the vehicle 1 is not towing the towed vehicle 3 (step S35).

Next, the control device 30 determines whether the vehicle 1 among the vehicle 1 and the towed vehicle 3 towed by the vehicle 1 has climbed over the step in the step section (step S42).

When it is determined in step S42 that the vehicle 1 has not climbed over the step (step S42: No), the control device 30 repeats the process of step S42 until the vehicle 1 climbs over the step. When it is determined in step S42 that the vehicle 1 has climbed over the step (step S42: Yes), the control device 30 causes the vehicle 1 towing the towed vehicle 3 to travel at a third speed lower than the second speed (step S43).

Next, the control device 30 determines whether the towed vehicle 3 among the vehicle 1 and the towed vehicle 3 towed by the vehicle 1 has climbed over the step in the step section (step S44).

When it is determined in step S44 that the towed vehicle 3 has not climbed over the step (step S44: No), the control device 30 repeats the process of step S44 until the towed vehicle 3 climbs over the step. When it is determined in step S44 that the towed vehicle 3 has climbed over the step, that is, when the towed vehicle 3 towed by the vehicle 1 has left the step section (step S44: Yes), the control device 30 returns to step S32.

As described above, the control device 30 generates the second travel route 242, which is a trajectory through which the towed vehicle 3 passes when the vehicle 1 towing the towed vehicle 3 travels on the first travel route 241, based on the towed vehicle information related to the towed vehicle 3 towed by the vehicle 1 and the route information when the vehicle 1 travels on the first travel route 241. According to the configuration, by performing the automated parking in consideration of a situation change caused by the vehicle 1 towing the towed vehicle 3, for example, a possibility of collision between the towed vehicle 3 towed by the vehicle 1 and the obstacles 213a, 213b, and 213c, safety of the vehicle 1 and the towed vehicle 3 towed by the vehicle 1 in the automated parking can be improved.

Further, according to the configuration, the automated parking of the vehicle 1 in a state of towing the towed vehicle 3 can be performed using the route information when the vehicle 1 travels without towing the towed vehicle 3. Thus, an opportunity to perform the automated parking can be increased, and convenience of the automated parking can be improved. Further, since it is not necessary to store the route information for the presence or absence of the towed vehicle 3 and a type of the towed vehicle 3, a storage capacity can be reduced.

For example, the control device 30 causes the navigation device 20 to display the first travel route 241, which is a trajectory through which the vehicle 1 passes, and the second travel route 242, which is a trajectory through which the towed vehicle 3 passes, on the external environment information in a superimposed manner. According to the configuration, the travel route to the destined parking position 220, on which the vehicle 1 and the towed vehicle 3 are about to travel, can be (visually) recognized as an image. Therefore, the safety of the automated parking can be further improved.

Further, when it is determined that the towed vehicle 3 cannot travel along the second travel route 242, the control device 30 issues a notification for prompting the user to change the first travel route 241 for the vehicle 1 to travel from the parking start position to the destined parking position 220. According to the configuration, the user can recognize that the towed vehicle 3 may collide with, for example, the obstacles 213a, 213b, and 213c when the automated parking is continued in this state, and the user can be notified of an operation to be performed to avoid the collision. Thus, the safety of the automated parking can be improved.

Further, when receiving an operation of changing one of the first travel route 241 and the second travel route 242 from the user, the control device 30 changes the other of the first travel route 241 and the second travel route 242 based on the travel route that has been changed based on the received change operation. According to the configuration, when the user performs an operation of changing one of the first travel route 241 and the second travel route 242, the other travel route is also changed according to the change operation, and thus operability of changing the travel route can be improved and the safety of the automated parking can be improved.

Further, when it is determined that the towed vehicle 3 cannot travel along the second travel route 242, the control device 30 changes the first travel route 241 such that the vehicle 1 and the towed vehicle 3 can travel from the parking start position to the destined parking position 220. According to the configuration, when it is determined that the towed vehicle 3 cannot travel along the second travel route 242, the first travel route 241 of the vehicle 1 can be automatically changed on a vehicle 1 side without receiving the change operation from the user. Thus, the safety of the automated parking can be improved.

Further, the control device 30 sets the travel speed of the vehicle 1 in a predetermined section among the sections to the destined parking position 220 to be lower when the vehicle 1 travels while towing the towed vehicle 3 than that when the vehicle 1 travels without towing the towed vehicle 3. According to the configuration, by reducing the travel speed of the vehicle 1 when the vehicle 1 is towing the towed vehicle 3, the safety of the automated parking can be improved even for a situation change in which the towed vehicle 3 having a large weight is towed.

Further, when the vehicle 1 towing the towed vehicle 3 travels to the destined parking position 220 and there is a step in a predetermined section of the route to the destined parking position 220, the control device 30 sets the travel speed of the vehicle 1 when the towed vehicle 3 climbs over the step to be lower than the travel speed of the vehicle 1 when the vehicle 1 climbs over the step. According to the configuration, an impact applied to the towed vehicle 3 when the vehicle 1 automatically travels on the route having a step can be limited. Thus, the safety of the automated parking can be improved.

Although various embodiments have been described above with reference to the drawings, it is needless to say that the present invention is not limited to these examples. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

The control method described in the above embodiment may be implemented by executing a program (control program) prepared in advance on a computer. For example, the control program is stored in a computer-readable storage medium and executed by being read from the storage medium. Further, the control program may be provided in a form of being stored in a non-transitory storage medium such as a flash memory, or may be provided via a network such as the Internet.

In the embodiment described above, the computer that executes the program is the control device 30 provided in the vehicle 1, but the present disclosure is not limited thereto. For example, the computer that executes the program may be provided in another device (for example, the external device 2) capable of communicating with the control device 30.

In the embodiment described above, a case where the display control unit 35 displays the overhead image and the 3D image on the touch panel 22 of the vehicle 1 has been described, but the present invention is not limited thereto. For example, the display control unit 35 may display the overhead image and the 3D image on a display screen of an information terminal (for example, a smartphone) carried by a passenger of the vehicle 1 via the communication unit 70.

In the present description, at least the following matters are described. In the parentheses, the corresponding constituent elements and the like in the above embodiment are shown as examples, but the present invention is not limited thereto.

(1) A control device (control device 30) for a moving object (vehicle 1) which autonomously moves from a parking start position to a destined parking position (destined parking position 220) and to which a towed vehicle (towed vehicle 3) is connectable, the control device including:
an external environment recognition unit (external environment recognition unit 31) configured to acquire external environment information related to a surrounding situation of the moving object;
a first acquisition unit (first acquisition unit 32) configured to acquire towed vehicle information related to the towed vehicle connected to the moving object;
a second acquisition unit (second acquisition unit 33) configured to acquire route information acquired when the moving object travels on a first travel route (first travel route 241) from the parking start position to the destined parking position; and
a movement control unit (movement control unit 34) configured to perform travel control of the moving object travelling to the destined parking position based on the external environment information and the route information,
in which the movement control unit generates, based on the towed vehicle information and the route information, a second travel route (second travel route 242) that is a trajectory through which the towed vehicle passes when the moving object to which the towed vehicle is connected travels on the first travel route.

According to the above (1), by performing the automated parking in consideration of a situation change caused by the towing of the towed vehicle (for example, a possibility of collision between the towed vehicle and an obstacle), safety of the automated parking can be improved.

(2) The control device according to the above (1) further including:
a display control unit (display control unit 35) configured to cause a display unit to display the first travel route and the second travel route.

According to the above (2), by causing a user to recognize the first travel route of the moving object and the second travel route of the towed vehicle, the safety of the automated parking can be improved.

(3) The control device according to the above (2),
in which the movement control unit determines, based on the route information, whether the towed vehicle is able to travel along the second travel route, and
the control device further includes a notification unit (notification unit 36) configured to, in a case where it is determined that the towed vehicle is not able to travel along the second travel route, issue a notification for promoting a user to change a travel route for the moving object to travel from the parking start position to the destined parking position.

According to the above (3), when the towed vehicle is not able travel along the second travel route (for example, in a case where the towed vehicle may collide with an obstacle), by notifying the user to change the travel route of the moving object, the safety of the automated parking can be improved.

(4) The control device according to the above (3),
in which in a case where an operation of changing one of the first travel route and the second travel route is received from the user, the movement control unit changes an other one of the first travel route and the second travel route based on the operation of changing.

According to the above (4), when the user performs an operation of changing one of the first travel route and the second travel route, the other travel route is also changed according to the change operation, and thus the safety of automated parking can be improved.

(5) The control device according to (1),
in which the movement control unit
determines, based on the route information, whether the towed vehicle is able to travel along the second travel route, and
changes, in a case where it is determined that the towed vehicle is not able to travel along the second travel route, the first travel route such that the moving object and the towed vehicle are able to travel from the parking start position to the destined parking position.

According to the above (5), when the towed vehicle is not able to travel along the second travel route, the first travel route can be changed on a moving object side without receiving the change operation of the user, and thus the safety of the automated parking can be improved.

(6) The control device according to the above (1),
in which the movement control unit sets, based on the route information, a travel speed of the moving object in a predetermined section among sections to the destined parking position to be lower in a case where the moving object travels while towing the towed vehicle than a case where the moving object travels without the towed vehicle.

According to the above (6), by reducing the travel speed of the moving object when traveling in the predetermined section, an impact on the moving object and the towed vehicle towed by the moving object can be limited, and the safety of automated parking can be improved.

(7) The control device according to the above (6),
in which the predetermined section includes a step, and
in the case where the moving object travels while towing the towed vehicle, the movement control unit sets, based on the towed vehicle information and the route information, the travel speed of the moving object to be lower when the towed vehicle climbs over the step than a moment when the moving object climbs over the step.

According to the above (7), when the moving object is towing the towed vehicle, the travel speed of the moving object when the towed vehicle climbs over the step is set to be lower than that when the moving object climbs over the step, and thus the impact on the towed vehicle can be limited, and the safety of automated parking can be improved.

(8) The control device according to any one of (1) to (7),
in which the movement control unit
determines, based on the route information, whether the towed vehicle is able to travel along the second travel route, and
performs the travel control for causing the moving object to travel to the destined parking position along the first travel route, in a case where it is determined that the towed vehicle is able to travel along the second travel route.

As in the above (8), when the towed vehicle is able to travel along the second travel route, it is preferable to cause the moving object to travel.

(9) The control device according to the above (8) further including:
a notification unit configured to, in a case where it is determined that the towed vehicle is not able to travel along the second travel route, issue a notification for prompting a user to perform a predetermined operation without performing the travel control for causing the moving object to travel to the destined parking position along the first travel route.

According to the above (9), when the towed vehicle is not able to travel along the second travel route, a notification for promoting the user to perform the predetermined operation can be issued without causing the moving object to travel, and thus the safety of automated parking can be improved.

(10) The control device according to any one of (1) to (9),
in which the movement control unit determines whether the towed vehicle is able to travel along the second travel route by predicting, based on the route information, whether the towed vehicle and a safe region around the towed vehicle collide with an obstacle when the moving object to which the towed vehicle is connected travels on the first travel route.

According to the above (10), when it is determined whether the towed vehicle is able to travel along the second travel route, by performing the determination in consideration of some margin space around the towed vehicle, the safety of the automated parking can be further improved.

(11) A control method in a control device for a moving object which autonomously moves from a parking start position to a destined parking position and to which a towed vehicle is connectable,
in which a processor of the control device performs the control method including:
   acquiring external environment information related to a surrounding situation of the moving object;
   acquiring towed vehicle information related to the towed vehicle connected to the moving object;
   acquiring route information acquired when the moving object travels on a first travel route from the parking start position to the destined parking position;
   performing travel control of the moving object travelling to the destined parking position based on the external environment information and the route information; and
   generating, based on the towed vehicle information and the route information, a second travel route that is a trajectory through which the towed vehicle passes when the moving object to which the towed vehicle is connected travels on the first travel route.

According to (11), by performing the automated parking in consideration of the situation change caused by the towing of the towed vehicle (for example, the possibility of the collision between the towed vehicle and the obstacle), the safety of the automated parking can be improved.

(12) A non-transitory computer-readable storage medium storing a control program of a control device for a moving object which autonomously moves from a parking start position to a destined parking position and to which a towed vehicle is connectable, the control program causing a processor of the control device to:
acquire external environment information related to a surrounding situation of the moving object;
acquire towed vehicle information related to the towed vehicle connected to the moving object;
acquire route information acquired when the moving object travels on a first travel route from the parking start position to the destined parking position;
perform travel control of the moving object travelling to the destined parking position based on the external environment information and the route information; and
generate, based on the towed vehicle information and the route information, a second travel route that is a trajectory through which the towed vehicle passes when the moving object to which the towed vehicle is connected travels on the first travel route.

According to (12), by performing the automated parking in consideration of the situation change caused by the towing of the towed vehicle (for example, the possibility of the collision between the towed vehicle and the obstacle), the safety of the automated parking can be improved.

What is claimed is:

1. A control device for a moving object which autonomously moves from a parking start position to a destined parking position and to which a towed vehicle is connectable, the control device comprising:
an external environment recognition unit configured to acquire external environment information related to a surrounding situation of the moving object;
a first acquisition unit configured to acquire towed vehicle information related to the towed vehicle connected to the moving object;
a second acquisition unit configured to acquire route information acquired when the moving object travels on a first travel route from the parking start position to the destined parking position; and
a movement control unit configured to perform travel control of the moving object travelling to the destined parking position based on the external environment information and the route information,
wherein the movement control unit generates, based on the towed vehicle information and the route information, a second travel route that is a trajectory through which the towed vehicle passes when the moving object to which the towed vehicle is connected travels on the first travel route.

2. The control device according to claim 1, further comprising:
a display control unit configured to cause a display unit to display the first travel route and the second travel route.

3. The control device according to claim 2,
wherein the movement control unit determines, based on the route information, whether the towed vehicle is able to travel along the second travel route, and
the control device further comprises a notification unit configured to, in a case where it is determined that the towed vehicle is not able to travel along the second travel route, issue a notification for promoting a user to change a travel route for the moving object to travel from the parking start position to the destined parking position.

4. The control device according to claim 3,
wherein in a case where an operation of changing one of the first travel route and the second travel route is received from the user, the movement control unit changes an other one of the first travel route and the second travel route based on the operation of changing.

5. The control device according to claim 1,
wherein the movement control unit
determines, based on the route information, whether the towed vehicle is able to travel along the second travel route, and
changes, in a case where it is determined that the towed vehicle is not able to travel along the second travel route, the first travel route such that the moving object and the towed vehicle are able to travel from the parking start position to the destined parking position.

6. The control device according to claim 1,
wherein the movement control unit sets, based on the route information, a travel speed of the moving object in a predetermined section among sections to the destined parking position to be lower in a case where the moving object travels while towing the towed vehicle than a case where the moving object travels without the towed vehicle.

7. The control device according to claim 6,
wherein the predetermined section includes a step, and
in the case where the moving object travels while towing the towed vehicle, the movement control unit sets, based on the towed vehicle information and the route information, the travel speed of the moving object to be lower when the towed vehicle climbs over the step than a moment when the moving object climbs over the step.

8. The control device according to claim 1,
wherein the movement control unit
determines, based on the route information, whether the towed vehicle is able to travel along the second travel route, and
performs the travel control for causing the moving object to travel to the destined parking position along the first travel route, in a case where it is determined that the towed vehicle is able to travel along the second travel route.

9. The control device according to claim 8, further comprising:
a notification unit configured to, in a case where it is determined that the towed vehicle is not able to travel along the second travel route, issue a notification for prompting a user to perform a predetermined operation without performing the travel control for causing the moving object to travel to the destined parking position along the first travel route.

10. The control device according to claim 1,
wherein the movement control unit determines whether the towed vehicle is able to travel along the second travel route by predicting, based on the route information, whether the towed vehicle and a safe region around the towed vehicle collide with an obstacle when the moving object to which the towed vehicle is connected travels on the first travel route.

11. A control method in a control device for a moving object which autonomously moves from a parking start position to a destined parking position and to which a towed vehicle is connectable,
wherein a processor of the control device performs the control method comprising:
acquiring external environment information related to a surrounding situation of the moving object;
acquiring towed vehicle information related to the towed vehicle connected to the moving object;
acquiring route information acquired when the moving object travels on a first travel route from the parking start position to the destined parking position;
performing travel control of the moving object travelling to the destined parking position based on the external environment information and the route information; and
generating, based on the towed vehicle information and the route information, a second travel route that is a trajectory through which the towed vehicle passes when the moving object to which the towed vehicle is connected travels on the first travel route.

12. A non-transitory computer-readable storage medium storing a control program of a control device for a moving object which autonomously moves from a parking start position to a destined parking position and to which a towed vehicle is connectable, the control program causing a processor of the control device to:
acquire external environment information related to a surrounding situation of the moving object;
acquire towed vehicle information related to the towed vehicle connected to the moving object;
acquire route information acquired when the moving object travels on a first travel route from the parking start position to the destined parking position;
perform travel control of the moving object travelling to the destined parking position based on the external environment information and the route information; and
generate, based on the towed vehicle information and the route information, a second travel route that is a trajectory through which the towed vehicle passes when the moving object to which the towed vehicle is connected travels on the first travel route.
